(19) United States
(12) Patent Application Publication
(10) Pub. No.: US 2011/0300421 A1
(43) Pub. Date: Dec. 8, 2011

(54) ELECTRIC POWER SOURCE DEVICE

(75) Inventors: Kunio IRITANI, Anjo-city (JP); Yoshimitsu Inoue, Chiryu-city (JP)

(73) Assignee: DENSO CORPORATION, Kariya-city (JP)

(21) Appl. No.: 13/152,425

(22) Filed: Jun. 3, 2011

(30) Foreign Application Priority Data
Jun. 4, 2010 (JP) 2010-129055
Apr. 13, 2011 (JP) 2011-89438

(51) Int. Cl. H01M 2/36; H01M 10/50

(52) U.S. Cl. 429/72; 429/120

(57) ABSTRACT

An electric power source device has multiple layered battery cells which are electrically connected in series and/or in parallel. The battery cells are accommodated in a battery casing, which has a heat insulating structure at a portion surrounding the battery cells. The power source device further has a heating unit between lower surfaces of the battery cells and a bottom plate of the battery casing. A heat storage layer is further provided between the heating unit and the bottom plate for storing the heat generated at the heating unit.

### CROSS REFERENCE TO RELATED APPLICATION

This application is based on Japanese Patent Applications No. 2010-129055 filed on Jun. 4, 2010 and No. 2011-089438 filed on Apr. 13, 2011, the disclosures of which are incorporated herein by reference.

### FIELD OF THE INVENTION

The present invention relates to an electric power source device having an aggregate, in which multiple battery cells are layered, for supplying electric power to an electric motor and so on

### BACKGROUND OF THE INVENTION

An electric power source device for an electric vehicle is known in the art, for example, as disclosed in Japanese Patent Publication No. 2008-140630, according to which multiple batteries are built in a battery casing. The conventional power source device has a hollow heat insulating layer at a lower side of the battery casing. Heat transfer fluid is filled in the hollow heat insulating layer, so that the heat transfer fluid can be moved in the inside thereof. According to such power source device, the heat transfer fluid is moved in the inside of the hollow heat insulating layer by vibration in a vertical direction during vehicle travel or by acceleration in a horizontal direction, which may be applied when the vehicle is accelerated, decelerated or turned. As a result, temperature of a lower portion of the battery casing is uniformized.

For example, according to the above prior art, even in a case that temperature difference is generated in the lower portion of the battery casing below the hollow heat insulating layer, the heat transfer fluid in the hollow heat insulating layer is agitated by the vehicle vibration and the like and thereby the temperature of the hollow heat insulating layer is uniformized. In other words, the temperature difference in the lower portion below the hollow heat insulating layer may not exert an influence on an upper portion of the battery casing above the hollow heat insulating layer.

According to the above prior art, however, in a cold weather season, such as a winter season, in which ambient temperature is low, an entire battery casing is cooled down when the temperature of air surrounding the battery casing is maintained at a low temperature for more than a predetermined time. Then, the temperature inside of the battery casing is also decreased and battery temperature becomes lower. Therefore, it is a problem that battery performance may be decreased.

### SUMMARY OF THE INVENTION

The present invention is made in view of the above problems. It is an object of the present invention to provide an electric power source device, according to which battery cells can be kept warm.

According to a feature of the present invention, an electric power source device has multiple battery cells, which are layered in a layer direction and electrically connected in series and/or in parallel. A battery casing accommodates the multiple battery cells, and the battery casing is composed of a heat insulating structure at a portion surrounding the battery cells. A heating unit is provided between lower surfaces of the battery cells and a bottom plate of the battery casing for heating the battery cells. A heat storage layer is further provided between the heating unit and the bottom plate of the battery casing for storing heat generated at the heating unit.

According to the above feature of the invention, the battery casing accommodating the multiple battery cells has the heat insulating structure at the portion surrounding the battery cells. It is, therefore, possible to suppress incomings and outgoings of heat between an inside and an outside of the battery casing. The power source device having a function of keeping the battery cells warm can be realized. In addition, since the heating unit is provided between the lower surfaces of the battery cells and the bottom portion of the battery casing, the air in the battery casing can be heated by the heating unit, whether or not the heating unit is directly or indirectly in contact with the battery cells. Therefore, the natural convection of the air, in which the heat is transferred from a lower portion toward an upper portion, is generated. As a result, temperature difference between the lower and upper portions of the battery casing and the battery cells can be balanced and thereby the battery cells are effectively heated.

Since the heat storage layer for storing the heat generated at the heating unit is further provided, heat quantity to be transferred to the lower surfaces 2b of the battery cells can be increased. Therefore, the effect for heating the battery cells can be further increased.

In addition, since the heat storage layer and the heating unit are arranged in this order from the bottom of the battery casing toward the lower surfaces of the battery cells, the battery cells can be quickly heated by the heating unit and at the same time the heat can be stored in the heat storage layer. As a result, when the heating unit is operated, the battery cells as well as the inside of the battery casing can be heated and the heat is stored in the heat storage layer. When the operation of the heating unit is stopped, the heat stored in the heat storage layer is transferred to the heating unit and the air in the battery casing to finally keep the battery cells warm.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic cross sectional view showing an inside structure of a battery casing of an electric power source device according to a first embodiment of the present invention;

FIG. 2 is a schematic cross sectional view showing an inside structure of a battery casing of an electric power source device according to a second embodiment of the present invention;

FIG. 3 is a schematic view showing a structure for a warm-keeping function of an electric power source device according to a third embodiment of the present invention;

FIG. 4 is a schematic view showing a structure for a warm-keeping function of an electric power source device according to a fourth embodiment of the present invention;

FIG. 5 is a schematic view showing a structure for a warm-keeping function of an electric power source device according to a fifth embodiment of the present invention;

FIG. 6 is a schematic plan view for explaining air flow in a battery casing of an electric power source device according to a sixth embodiment of the present invention;

FIG. 7 is a schematic cross sectional view taken along a line VII-VII in FIG. 6; and

FIG. 8 is a schematic cross sectional view taken along a line VIII-VIII in FIG. 6.

### DETAILED DESCRIPTION OF THE PREFERRED EMBODIMENTS

An electric power source device of the present invention will be explained by way of multiple embodiments with reference to the drawings.

The same reference numerals are used throughout the embodiments for the purpose of designating the same or similar part or portion, to thereby omit repeated explanation as much as possible.

### First Embodiment

An electric power source device of the present invention is applied to a hybrid vehicle having a driving power source combining an internal combustion engine with an electric motor operated by electric power charged in a battery, or the present invention may be further applied to an electric vehicle having a driving power source of an electric motor. The electric power source device supplies electric power to such a vehicle driving motor. The electric power is charged in respective battery cells forming a battery pack. Each of the battery cells is composed of, for example, a nickel metal-hydride secondary battery, a lithium-ion secondary battery, an organic radial battery and so on. The battery cells are accommodated in a battery casing, which is located in a space beneath a vehicle seat, a space between a rear seat and a trunk room, a space between a driver seat and a passenger seat and so on.

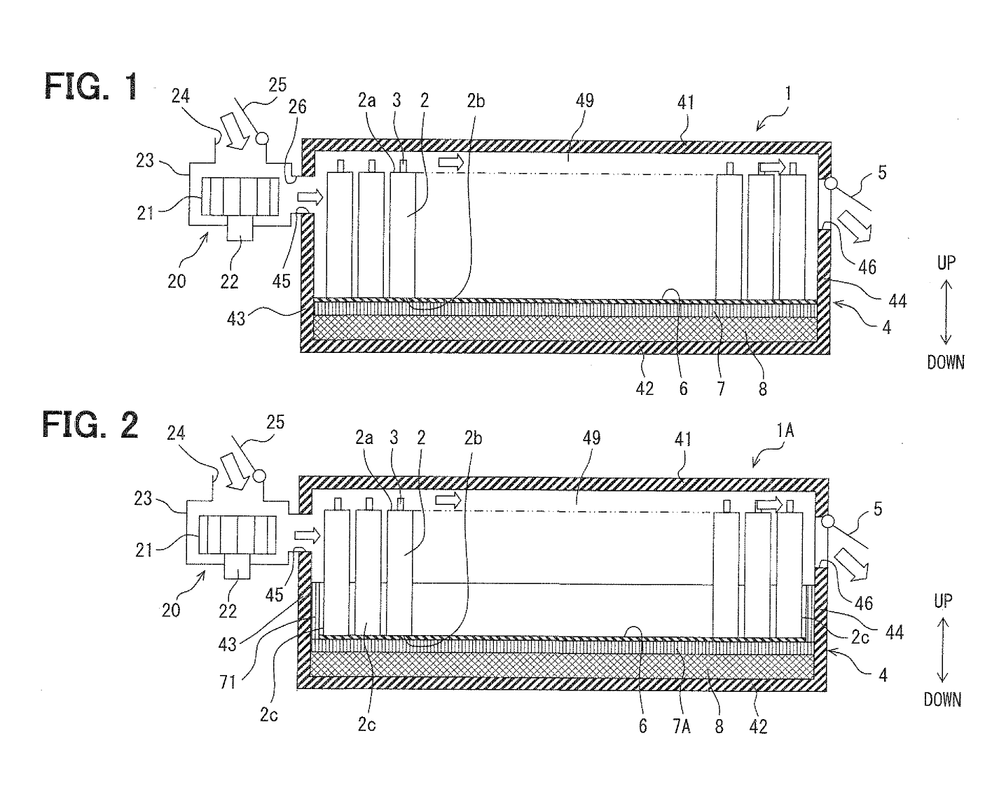

A first embodiment of the present invention will be explained with reference to FIG. 1. FIG. 1 is a schematic cross sectional view showing an inside structure of a battery casing 4 of an electric power source device 1 according to the first embodiment.

A battery pack, which is an aggregate in which multiple battery cells 2 are layered, is controlled by electronic parts and components (not shown) used for charging and discharging or temperature control of the battery cells 2. The battery cells 2 are cooled down by air from an air blower unit 20. In the battery pack, multiple battery cells 2 are electrically connected in series and/or in parallel to each other and integrally layered in such an aligned manner that side surfaces of the respective battery cells 2 are opposed to each other. The battery pack is accommodated in the battery casing 4. The above mentioned electronic parts and components correspond to such electronic parts and components and various kinds of electronic control units, which control relays, an electric motor 22 of the air blower unit 20, inverters and so on.

The battery casing 4 is a cuboidal housing made of resin or steel, at least one side wall of which is detachably formed so that maintenance work may be easily carried out. An attachment portion (not shown), with which the battery casing 4 is fixed to a vehicle chassis by bolts, as well as a component accommodating portion (not shown) is provided in the battery casing 4.

The component accommodating portion accommodates therein a battery monitoring unit (not shown), to which detected results from various kinds of sensors for monitoring battery condition (for example, voltage, temperature and so on) are inputted, a control device for controlling relays communicated with the battery monitoring unit and operation of the electric motor 22 of the air blower unit 20, a wire harness assembly for connecting various components with each other, and so on The battery monitoring unit is a battery ECU (an electronic control unit for the battery) for monitoring the conditions of the battery cells 2 and connected to the respective battery cells 2 via multiple wirings.

As shown in FIG. 1, in the battery pack, the multiple battery cells 2 are integrally held as one unit, wherein the side surfaces (which are perpendicular to a layer direction) of the rectangular-shaped battery cells 2 are pressed to each other by a binding device (not shown). For example, a pair of binding plates (not shown) arranged at both ends of the layered battery cells 2 in the layer direction are linked to each other by multiple rods (not shown), so that the respective battery cells 2 receive a compression force by external force directing toward inside from the both ends. As a result, the respective battery cells 2 are bound to each other. The rods are made of material having high strength, such as metal or hard resin, so that the multiple battery cells 2 are integrated as one unit by a stable force.

Each of the battery cells 2 is formed in a flat cuboid, outer surfaces of which are covered by outer packaging members. Terminals 3 including a positive electrode and a negative electrode are provided at an upper surface 2a of the respective battery cells 2 in such a manner that the terminals 3 protrude from the outer packaging member in an upward direction. The upper surface 2a of the battery cell 2 is arranged at a position having a space from a ceiling plate 41 of the battery casing 4. Each top end of the terminals 3 is also arranged so that a certain gap is formed between the top end of the terminal and the ceiling plate 41. All of the battery cells 2 accommodated in the battery casing 4 are connected in series by respective bus bars (not shown), which respectively connect the terminals of the neighboring battery cells 2. The electric current flows from one of the terminals (the positive electrode) located at one end of the layer direction to the other terminal (the negative electrode) located at the other end of the layered direction, wherein the electric current goes and returns in the respective battery cells 2 in a direction perpendicular to a direction of fluid (the air in the present embodiment) flowing in the battery pack.

As above, the respective neighboring battery cells 2 in the layer direction are electrically connected so that the electric current flows one to the other. All of the battery cells 2 forming the battery pack are electrically connected in series by the bus bars, which connect the respective neighboring battery cells 2, so that the electric current flows in a zigzag pattern or a meandering pattern from the terminal 3 of the battery cell 2 located at the end of the layer direction to the other terminal 3 of the battery cell 2 located at the other end of the layer direction. A fin portion outwardly projecting may be provided in each of the bus bars. The fin portion corresponds to a portion which expands a heat transfer area. The fin portion is brought into contact with the air and contributes in improving cooling performance. Multiple louvers may be preferably provided in the fin portion by cutting and bending up so as to further improve the cooling performance.

The battery casing 4 has a heat insulating structure at a portion surrounding the multiple battery cells 2. For example, the entire battery casing 4 may be made of the heat insulating structure. The battery casing 4 may be made of material having adiathermancy. Heat insulating sheets may be attached to a relevant portion of the battery casing 4. Alternatively, a heat insulating space (a vacuum space) or a heat insulating layer made of heat insulating material may be formed at a relevant portion of the battery casing 4. Furthermore, the battery casing 4 may be made of the heat insulating material, such as FRP (fiber reinforced plastic) of expanding type having low heat conduction and high strength. The heat insulating material may be, for example, urethane foam of the expanding type. In addition, the heat insulating structure may be further provided with electromagnetic shielding function.

The power source device 1 has a heating unit 7 in the battery casing 4 between lower surfaces 2b of the battery cells 2 and a bottom plate 42 of the battery casing 4. The heating unit 7 is composed of a heat generating element for heating the multiple battery cells 2 accommodated in the battery casing 4 from a lower side of the respective battery cells 2. The heating unit 7 may be made of, for example, a sheet-shape heat generating member in which heat is generated by the electric current flowing through a metal foil, a PTC (positive temperature coefficient) heater having a heat generating portion for generating heat when the electric current flows through the heat generating portion, a film heater in which an electric circuit is formed by printing PTC ink (having a self temperature control function) and conductive paste, and so on.

The heating unit 7 is operated to quickly heat the battery cells 2 when the vehicle travels in the winter season, so that the temperature of the battery cells 2 is raised to a proper temperature at which the battery cells 2 perform properly (that is, the temperature at which the battery cells 2 carries out properly the charging and discharging operation). In a case that the PTC heater is provided as the heating unit 7, the heat generating portion may be formed that multiple PTC elements are inserted into resin frames made of resin material having high heat resisting properties (for example, 66 nylon, polybutadiene terephthalate resin, and so on).

According to the power source device 1, an electric insulating layer 6 having heat conduction and electric insulation is provided between the lower surfaces 2b of the battery cells 2 and the heating unit 7. The electric insulating layer 6 is formed of, for example, a thin film layer made of silicon rubber, resin, or ceramics. The electric insulating layer 6 may be formed by a deposition method, a coating method, or an integral forming method. Since the outer packaging members of the battery cells 2 and the heating unit 7 are indirectly contacted with each other via the electric insulating layer 6, electric insulation between them can be assured. In other words, electric safety can be assured. The electric insulating layer 6 may be also made of an aluminum nitride film, a silicon rubber sheet or the like. Furthermore, a heat radiating film having electric insulation may be used as the electric insulating layer 6. The heating unit 7 maybe arranged so as to be directly in contact with the lower surfaces 2b of the battery cells 2, unless a problem for the electric insulation may occur.

The power source device 1 further has a heat storage layer 8 made of a thermal storage medium for storing the heat generated by the heating unit 7. The heat storage layer 8 is so formed that the thermal storage medium (for example, a latent heat storage material, such as paraffin) is filled in a container so that a plate shape can be maintained. The heat storage layer 8 is arranged between the heating unit 7 and the bottom plate 42 of the battery casing 4. Therefore, the heat storage layer 8 is in direct contact with the heating unit 7 at an upper side and with the bottom plate 42 at a lower side almost in the whole area of the bottom plate 42. In addition, the heating unit 7 is in direct contact with the electric insulating layer 6 at an upper side and with the heat storage layer 8 at a lower side almost in the whole area of the bottom plate 42. The heat storage layer 8 stores the heat of the heating unit 7 during it is operated, so that the stored heat can be used to keep the battery cells warm during the vehicle is stopped in a nighttime in which the ambient temperature becomes lower.

As shown in FIG. 1, the air blower unit 20 is integrally provided with the battery casing 4. The air blower unit 20 is composed of a sirocco fan 21 driven by the electric motor 22, a rotational speed of which can be controlled, and a blower casing 23 for accommodating the sirocco fan 21. The blower casing 23 has an air intake port 24 through which the air (vehicle inside air or vehicle outside air) is taken into the blower casing 23 and an air blowing port 26 from which the air is blown out. The air blowing port 26 is opened to the inside of the blower casing 23 in a direction of centrifugal force. A door (an air intake door) 25 is provided for opening or closing the air intake port 24. The inside of the blower casing 23 is communicated to the inside space of the battery casing 4 via the air blowing port 26. The air blower unit 20 supplies the cooling air into the battery pack as indicated by arrows in FIG. 1.

The battery casing 4 has an air inlet opening 45, which is connected to the air blowing port 26 of the blower casing 23, at a side wall portion 43 (at an upstream side of the cooling air from the air blower unit 20). The battery casing 4 also has an opening (that is, an air discharge opening 46) at a side wall portion 44 (at a downstream side of the cooling air), so that the cooling air is discharged from the air discharge opening 46. A door (an air discharge door) 5 is provided for opening or closing the air discharge opening 46. The air inlet opening 45 and the air discharge opening 46 respectively correspond to an air inlet port and an air outlet port for the cooling air in the inside space of the battery casing 4 and they are provided at the respective side wall portions 43 and 44 opposing to each other.

An operation (opening or closing operation) of the door 25 provided at the blower casing 23 as well as the door 5 provided at the battery casing 4 is controlled by a control unit (not shown) depending on a condition in which the cooling air is supplied to control the temperature of the multiple battery cells 2 accommodated in the battery casing 4 or on a condition in which the cooling air is not supplied into the battery pack. In other words, when it is not necessary to cool down the battery cells 2 in the battery casing 4 or when it is necessary to keep the battery cells 2 warm, the doors 25 and 5 are closed to stop the air flow in the inside apace of the battery casing 4.

When no forced convection of the air is generated in the inside space of the battery casing 4 (that is, a cell accommodating space 49 for the battery cells 2), incomings and outgoings of the air between the inside and outside of the battery casing 4 can be blocked off by closing the doors 25 and 5. As a result, the heat from the heating unit 7 and/or the heat storage layer 8 is blocked in the cell accommodating space 49, so that warmth retaining property can be improved to thereby properly bring out the battery performance.

When the air blower unit 20 is operated in a condition that the air intake port 24 is opened, the air is taken into the air blower unit 20 via the air intake port 24 and the air is blown out into the inside of the battery casing 4 via the air blowing port 26. The air from the air blowing port 26 flows toward the air discharge opening 46 along the upper surfaces 2a and side surfaces of the respective battery cells 2. When the cooling air flows in the inside of the battery casing 4, the air is brought into contact with the respective terminals 3, bus bars, fin portions, outer packaging members and so on to thereby absorb the heat therefrom and to cool down the battery cells 2. The heat collected by the cooling air is discharged to the outside of the battery casing 4 through the air discharge opening 46.

Advantages of the power source device 1 of the present embodiment will be explained. The power source device 1 has multiple battery cells 2 which are layered and electrically connected in series and/or in parallel to each other. The power source device 1 has the battery casing 4, which accommodates the multiple battery cells 2 and has a heat insulating structure at such a portion surrounding the battery cells 2. The power source device 1 further has the heating unit 7, which is provided in the battery casing 4 between the lower surfaces 2b of the battery cells 2 and the bottom plate 42 of the battery casing 4 for heating the battery cells 2.

For example, when the ambient temperature of the battery casing 4 is low, for example, when it is in a low temperature circumstance in the nighttime of the winter season, the air inside of the battery casing is easily cooled down and thereby the temperature of the battery cells become lower in a case that the battery casing has no heat insulating structure. In such a case, the temperature of the battery cells becomes lower than the proper operating temperature for charging and/or discharging operation. It is, therefore, difficult to bring out the desired battery performance. In addition, in a case that the operation is repeated in the low temperature condition, degradation of the battery cells may be facilitated. On the other hand, when the power source device 1 is left in a circumstance in which the ambient temperature is higher than that of the battery cells, the temperature of the air inside of the battery casing is easily increased and thereby the temperature of the battery cells is increased, in a case that the battery casing has no heat insulating structure. When the power source device is repeatedly used in such a condition, the degradation of the battery cells may be likewise facilitated.

According to the present embodiment, however, the heat insulating structure is provided at such a portion of the battery casing 4 surrounding the battery cells 2 in order that the incomings and outgoings of the heat between the inside and outside of the battery casing 4 are suppressed. As a result, the power source device having the function for keeping the battery cells 2 at proper temperature is obtained. When the environmental temperature of the power source device 1 is low, it is possible to prevent the temperature decrease of the battery cells and to maintain the temperature of the battery cells at the proper operating temperature for charging and discharging operation. In addition, since the heating unit 7 is provided in the battery casing 4 between the lower surfaces 2b of the battery cells 2 and the bottom plate 42 of the battery casing 4, the heat transfer is facilitated from the lower portion to the upper portion of the battery casing 4. Namely, the heat transfer is carried out by the heat conduction to the battery cells 2 as well as the convection of the air in the battery casing 4. Temperature balance between the lower and upper portions of the battery cells as well as the temperature difference in the battery casing can be properly controlled.

The heat insulating structure may be preferably provided at the whole area of the battery casing 4, so that the function for keeping the battery cells warm as well as the function for cooling down the battery cells can be properly carried out.

In addition, the power source device 1 has the heat storage layer 8 made of the thermal storage medium, which is provided between the heating unit 7 and the bottom plate 42 of the battery casing 4 for storing the heat generated at the heating unit 7.

According to such structure, the heat quantity to be transferred to the battery cells 2 can be increased, to thereby increase the heating function for the battery cells 2. Since the heat storage layer 8 and the heating unit 7 are provided in the battery casing 4 in this order from the bottom plate 42 toward the lower surfaces 2b of the battery cells 2, the battery cells 2 can be quickly heated and at the same time the heat storage can be carried out in the heat storage layer 8. When the heating unit 7 is not operated, the battery cells 2 can be maintained at the proper temperature by the heat stored in the heat storage layer 8.

The heating unit 7 is directly in contact with the lower surfaces 2b of the battery cells 2 or indirectly in contact with the lower surfaces 2b via the electric insulating layer 6 having the heat conduction. According to such structure, the heat of the heating unit 7 can be transferred, directly or indirectly via the electric insulating layer 6, to the battery cells 2. As a result, efficiency of the heat transfer can be increased to thereby effectively heat the battery cells 2.

The heating unit 7 is composed of the heat generating element, which generates the heat when the electric current is supplied thereto. The outer packaging members of the battery cells are made of the conducting material. The electric insulating layer 6 having the heat conduction is provided between the heating unit (the heat generating element) and the lower surfaces 2b of the battery cells. According to such structure, the electric insulation is assured between the heating unit 7 and the battery cells 2 and the electric safety is obtained. In addition, corrosion of the conducting material for the outer packaging members of the battery cells 2, which would be caused by differences of voltages between the neighboring battery cells 2, can be suppressed.

The terminals 3 of the positive and negative electrodes are protruded from the upper surfaces 2a of the battery cells. Since the terminals 3 are protruded from the upper surfaces 2a, which are opposite sides of the lower surfaces 2b to which the heat is directly transferred from the heating unit 7, the terminals 3 may not be directly influenced by the heat from the heating unit 7. The heat is likely to be generated at the terminals 3 at the charging and/or discharging operation. It is, however, possible to suppress the temperature increase in the vicinity of the terminals 3. In addition, a structure for cooling down the vicinity of the terminals 3 can be simplified. As a result, a number of parts and components as well as manufacturing cost can be lowered.

### Second Embodiment

An electric power source device 1A according to a second embodiment will be explained with reference to FIG. 2. FIG. 2 is a schematic cross sectional view showing an inside structure of the battery casing 4 of the electric power source device 1A.

As shown in FIG. 2, the power source device 1A has a second heating unit 71 at side surfaces 2c of the battery cells 2 such that the second heating unit 71 surrounds the battery cells 2 in a circumferential direction. The power source device 1A has a first heating unit 7A, which is identical to the heating unit 7 of the first embodiment. The second heating unit 71 as well as the first heating unit 7A is made in the same manner to the heating unit 7 and has the same effect to the heating unit 7. The other structure of the second embodiment is the same to that of the first embodiment.

According to the power source device 1A, the first heating unit 7A is provided between the lower surfaces 2b of the battery cells 2 and the bottom plate 42 of the battery casing 4, and the second heating unit 71 is provided between the side surfaces 2c of the battery cells 2 and the side wall portions 43 and 44 of the battery casing 4. According to such structure, since the side surfaces 2c of the battery cells 2 are also heated by the second heating unit 71, the battery cells 2 are totally heated from the lower surfaces 2b and side surfaces 2c. As a result that the battery cells are heated by the larger area, the battery cells of the second embodiment can be heated more effectively than the first embodiment.

### Third Embodiment

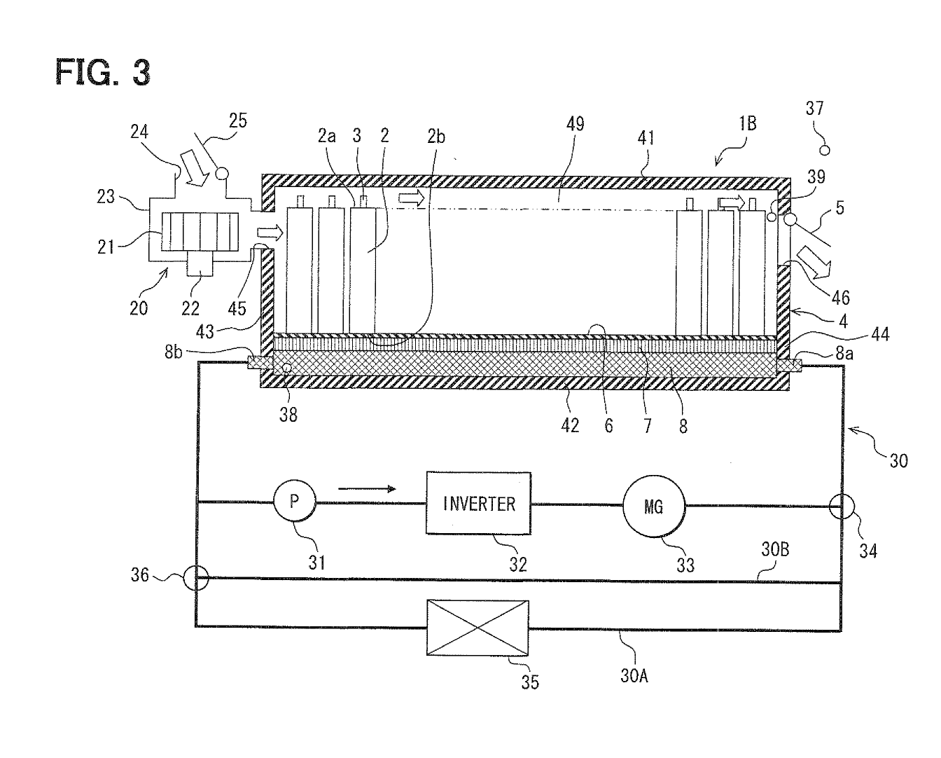

An electric power source device 1B according to a third embodiment will be explained with reference to FIG. 3. FIG. 3 is a schematic view showing a structure for a warm-keeping function of the electric power source device 1B.

As shown in FIG. 3, the power source device 1B has a first cooling water circuit 30, which is a closed circuit being composed of a pump 31, an inverter 32, a motor generator 33 and the heat storage layer 8. The power source device 1B further has a second cooling water circuit 30A, which connects an inlet-side passage of the first cooling water circuit 30 with an outlet-side passage of the first cooling water circuit 30. The inlet-side passage is connected to an inlet portion 8a of the heat storage layer 8, while the outlet-side passage is connected to an outlet portion 8b of the heat storage layer 8. A heat exchanger 35 is provided in the second cooling water circuit 30A. In addition, the power source device 1B has a bypass circuit 30B, which bypasses the heat exchanger 35 provided in the second cooling water circuit 30A.

In the first cooling water circuit 30, the cooling water (for example, the water including ethylene glycol) is circulated by the pump 31. A downstream side of the motor generator 33 is connected to a three-way valve 34, from which the first cooling water circuit 30 is branched out to the inlet-side passage and the second cooling water circuit 30A. The three-way valve 34 switches over the water flow either to the inlet-side passage of the first cooling water circuit 30 or to the second cooling water circuit 30A. A thermo valve 36 is provided in the second cooling water circuit 30A at a downstream side of the heat exchanger 35. One end of the bypass circuit 30B is connected to the thermo valve 36, which is then connected to the first cooling water circuit 30 at an upstream side of the pump 31. The thermo valve 36 is composed of a three-way valve, so that the water flow is switched to either the flow through the second cooling water circuit 30A or to the flow through the bypass circuit 30B depending on the temperature of the water at the downstream side of the heat exchanger 35. More exactly, when the water temperature at the downstream side of the heat exchanger 35 is higher than a predetermined value, the second cooling water circuit 30A is opened so that the cooling water flows through the heat exchanger 35. On the other hand, when the water temperature is lower than the predetermined value, the cooling water bypasses the heat exchanger 35 and flows through the bypass circuit 30B.

When the cooling water is allowed by the three-way valve 34 to flow through the first cooling water circuit 30, the cooling water having passed through the inverter 32 and the motor generator 33 is supplied to the heat storage layer 8 provided in the battery casing 4. Therefore, the cooling water circulating in the first cooling water circuit 30 is such a fluid, which absorbs the heat from the inverter 32 and the motor generator 33 to thereby cool down those components and by which the heat thus absorbed is stored in the heat storage layer 8. In other words, the inverter 32 and the motor generator 33 correspond to a heat absorbing portion for the heat storing fluid (the cooling water), while the heat storage layer 8 is a heat radiating portion for the heat storing fluid.

A control unit (not shown) controls operations of the pump 31, the inverter 32, the motor generator 33 and the three-way valve 34, in order to control transfer of the heat generated in the vehicle. The inverter 32 is an electronic component for supplying electric power to the motor generator 33. The inverter 32 has power devices for controlling such power supply. The power devices are composed of, for example, transistors and diodes, which are switching elements for switching on or off electric circuits for controlling the power supply.

According to the power source device 1B of the present embodiment, an ambient temperature sensor 37 and a water temperature sensor 38 are provided for respectively detecting ambient temperature of the power source device 1B and water temperature of the cooling water in the heat storage layer 8. When the vehicle is traveling and the control unit (not shown) determines based on the detected temperatures of the sensors 37 and 38 that the ambient temperature is higher than a predetermined value, the three-way valve 34 is operated by the control unit so that the first cooling water circuit 30 is closed. Then, the cooling water, which has passed through and cooled down the inverter 32 and the motor generator 33, flows through either the second cooling water circuit 30A or the bypass circuit 30B depending on the temperature detected by the thermo valve 36. In a case that the control unit determines based on the detected temperatures of the sensors 37 and 38 that the ambient temperature is lower than the predetermined value, the three-way valve 34 is switched over when the vehicle is stopped, so that the hot water is allowed to flow through the first cooling water circuit 30 and flow into the heat storage layer 8. Then, the heat storage layer 8 keeps the battery cells warm during the vehicle is stopped in the nighttime. When the vehicle is operated again to travel, the three-way valve 34 is so controlled that the hot water passing through the inverter 32 and the motor generator 33 flows through the heat storage layer 8 until the water temperature detected by the temperature sensor 38 reaches at a predetermined value. Thereafter, the three-way valve 34 is switched over so that the hot water passing through the electrical components (the inverter 32 and the motor generator 33) flows through either the second cooling water circuit 30A (having the heat exchanger 35) or the bypass circuit 30B.

According to the present embodiment, since the heat collected from the electrical components 32 and 33 can be used for heating the battery cells 2, heating efficiency can be further increased. In addition, since the energy to be supplied to the heating unit 7 can be reduced by such an amount corresponding to the heat collected from the electrical components 32 and 33, energy saving can be realized.

### Fourth Embodiment

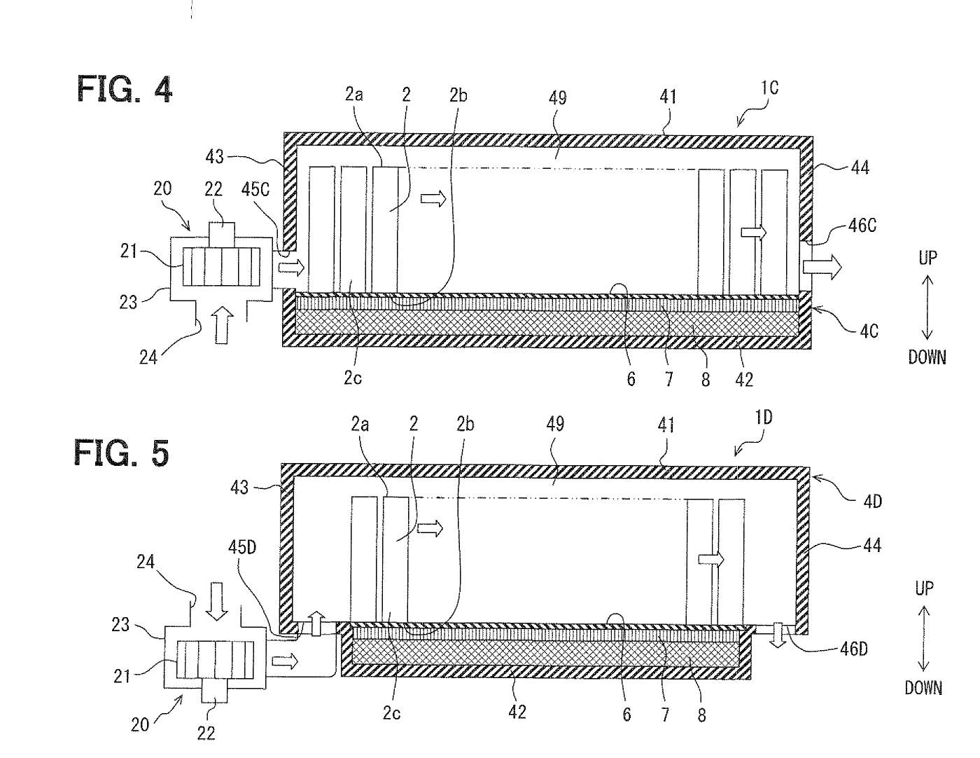

An electric power source device 10 according to a fourth embodiment will be explained with reference to FIG. 4. FIG. 4 is a schematic view showing a structure for a warm-keeping function of the electric power source device 10.

According to the power source device 10, an air inlet opening 450, through which the cooling air from the air blower unit 20 is supplied into an inside of a battery casing 40, and an air outlet opening 460, through which the cooling air is discharged to the outside of the battery casing 40, are provided in the battery casing 40 at lower portions thereof. More exactly, the air inlet and outlet openings 450 and 460 are provided at the lower portions of the battery casing 40, which are located at portions lower than a half height of the battery casing 40.

As shown in FIG. 4, the air inlet opening 45C is opened to the cell accommodating space 49 at the side wall portion 43 of the battery casing 4C, which is higher than the lower surface 2b of the battery cells 2. In a similar manner, the air outlet opening 46C is opened to the cell accommodating space 49 at the side wall portion 44 of the battery casing 4C, which is higher than the lower surface 2b of the battery cells 2.

According to the power source device 10 shown in FIG. 4, doors are not provided at the air inlet and outlet openings 45C and 46C for forcibly blocking the air flow. However, the doors corresponding to the air intake door 25 and the air discharge door 5 of the first embodiment may be provided.

When the air blower unit 20 is operated, the air is taken from the air intake port 24 and blown out from the air inlet opening 45C into the inside of the battery casing 4C. The cooling air supplied into the cell accommodating space 49 flows toward the upper and side portions of the respective battery cells 2 and passes through the cell accommodating space 49 from the air inlet opening 45C to the air outlet opening 46C. The cooling air are brought into contact with the terminals 3, the bus bars, the fin portions and outer packaging members of the battery cells and absorbs the heat from them to thereby cool down the battery cells 2. As above, the heat of the battery cells 2 is absorbed by the cooling air and discharged to the outside of the power source device through the air outlet opening 46C.

According to the present embodiment, each of the air inlet opening 45C and the air outlet opening 460 is provided at the side wall portion 43, 44 of the battery casing 4C at such lower portion, which is lower than the half height of the battery casing 4C.

According to such a structure, the air heated by the battery cells 2 is collected at the upper portion of the cell accommodating space 49. Therefore, when the operation of the air blower unit 20 is stopped and thereby the forced convection of the air is not generated, the heated air hardly flows out of the battery casing 4C through the air outlet opening 46C and/or the air inlet opening 450 due to the natural convection of the air. As a result, the heat is not discharged to the outside of the battery casing 4C. Therefore, the power source device 1C has a function for keeping the inside of the battery casing 4C warm.

According to the power source device 1C of the present embodiment, the air inlet opening 45C is provided at the side wall portion 43, while the air outlet opening 46C is provided at the side wall 44 which is opposite to the side wall portion 43.

When it becomes necessary to cool down the battery cells 2, the air blower unit 20 is operated to generate the forced convection of the air so that the air is taken from the air inlet opening 450 into the inside of the battery casing 40 and discharged to the outside through the air outlet opening 46C, which is located at the opposite side of the air inlet opening 45C, after having cooled down the battery cells 2. As a result, it is possible to totally and equally cool down the battery cells 2. Therefore, the power source device 1C has a function for effectively controlling the temperature of the battery cells 2.

### Fifth Embodiment

An electric power source device 1D according to a fifth embodiment will be explained with reference to FIG. 5. FIG. 5 is a schematic view showing a structure for a warm-keeping function of the electric power source device 1D.

According to the power source device 1D, an air inlet opening 45D, through which the cooling air from the air blower unit 20 is supplied into an inside of a battery casing 4D, and an air outlet opening 46D, through which the cooling air is discharged to the outside of the battery casing 4D, are provided in the battery casing 4C at bottom portions thereof. The bottom portion of the battery casing 4D may include a part of the bottom plate 42 of the battery casing 4D, which is not in parallel to the side wall portions 43 and 44. The air inlet and outlet openings 45D and 46D are openings opened in the vertical direction.

As shown in FIG. 5, the air inlet opening 45D is provided at the portion of the bottom plate 42, which is formed at the same level to the lower surfaces 2b of the battery cells 2. In a similar manner, the air outlet opening 46D is provided at the portion of the bottom plate 42, which is formed at the same level to the lower surfaces 2b of the battery cells 2. The battery cells 2 are not located above the air inlet and, outlet openings 45D and 46D. The air inlet and outlet openings 45D and 46D are formed in the bottom plate 42 at side ends of the heating unit 7 in the direction of the layered battery cells 2.

In a similar manner to the fourth embodiment (FIG. 4), when the air blower unit 20 is operated, the air is taken from the air intake port 24 and blown out from the air inlet opening 45D into the inside of the battery casing 4D. The cooling air supplied into the cell accommodating space 49 flows toward the upper and side portions of the respective battery cells 2 and passes through the cell accommodating space 49 from the air inlet opening 45D to the air outlet opening 46D. The cooling air is brought into contact with the terminals 3, the bus bars, the fin portions and outer packaging members of the battery cells and absorbs the heat from them to thereby cool down the battery cells 2. As above, the heat of the battery cells 2 is absorbed by the cooling air and discharged to the outside of the power source device through the air outlet opening 46D.

According to the power source device 1D, the air heated by the battery cells 2 is collected at the upper portion of the cell accommodating space 49. Therefore, when the operation of the air blower unit 20 is stopped and thereby the forced convection of the air is not generated, the heated air hardly flows out of the battery casing 4D through the air outlet opening 46D and/or the air inlet opening 45D due to the natural convection. As a result, the heat is not discharged to the outside of the battery casing 4D. Therefore, the power source device 1D has a function for keeping the inside of the battery casing 4D warm.

### Sixth Embodiment

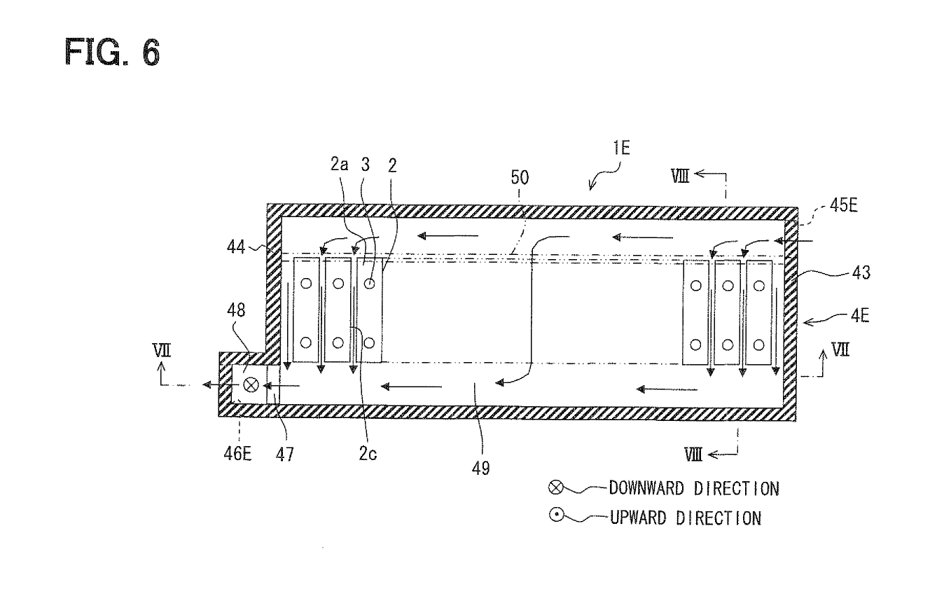

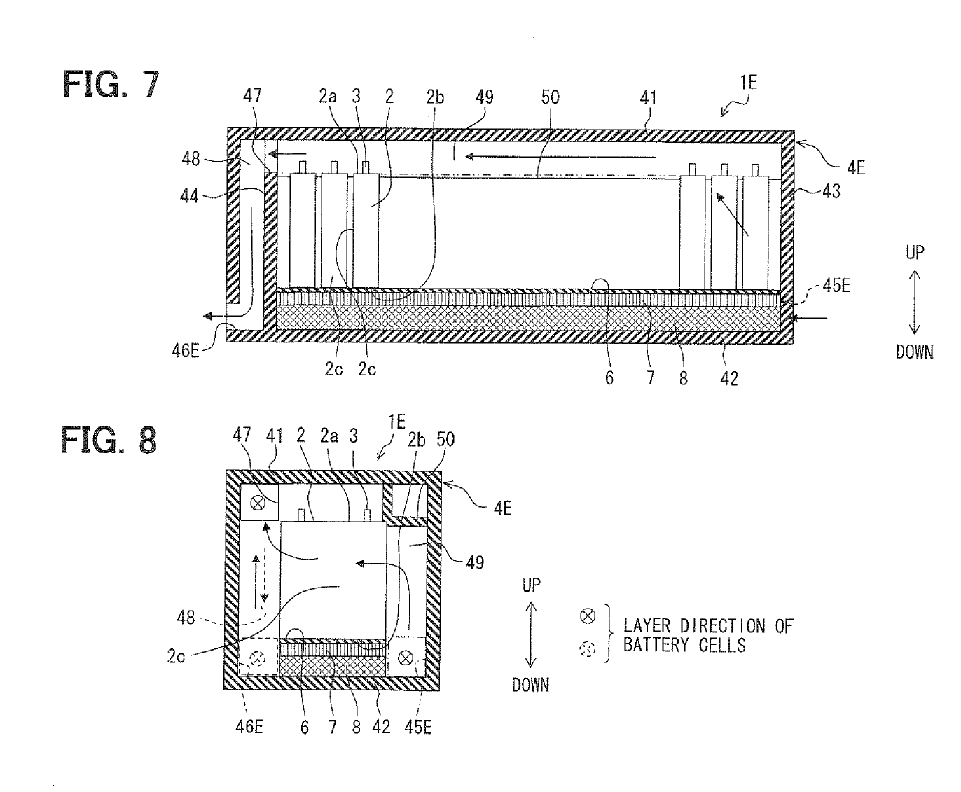

An electric power source device 1E according to a sixth embodiment will be explained with reference to FIGS. 6 to 8. FIG. 6 is a schematic plan view for explaining air flow in a battery casing 4E of an electric power source device 1E according to the sixth embodiment. FIG. 7 is a schematic cross sectional view taken along a line in FIG. 6, and FIG. 8 is a schematic cross sectional view taken along a line in FIG. 6.

According to the power source device 1E, an air inlet opening 45E is opened to a lower portion of the cell accommodating space 49, while an air outlet opening 46E is communicated to an upper portion of the cell accommodating space 49 via a communication passage 48 extending in a vertical direction. The lower portion of the cell accommodating space 49 means a part of the space located below a half height of the cell accommodating space 49, while the upper portion of the cell accommodating space 49 means a part of the space located above the half height of the cell accommodating space 49. The air inlet opening 45E is preferably formed in the side wall portion 43 of the battery casing 4E, wherein the opening 45E has a predetermined height from the bottom plate 42 of the battery casing 4E in the upward direction. The air outlet opening 46E is communicated to the cell accommodating space 49 via the communication passage 48 and an upstream-side opening 47, which is formed in the side wall portion 44 of the battery casing 4E at an upper portion thereof. The opening 47 has a predetermined height from the ceiling plate 41 of the battery casing 4E in the downward direction.

The lower portion of the cell accommodating space 49, to which the air inlet opening 45E is opened, is located at the lower portion of the side wall portion 43 of the battery casing 4E. The upper portion of the cell accommodating space 49, to which the air outlet opening 46E is communicated via the communication passage 48, is located at the upper portion of the side wall portion 44 of the battery casing 4E, which is provided at the opposite side of the side wall portion 43. As shown in FIG. 8, the lower portion of the cell accommodating space 49, to which the air inlet opening 45E is opened, and the upper portion of the cell accommodating space 49, to which the air outlet opening 46E is communicated, are diagonally arranged to each other. For example, when viewed the power source device from the top side, as shown in FIG. 6, the air inlet opening 45E is located at an upper-right end of a rectangular space formed by opposing side wall portions, while the air outlet opening 46E is located at a lower-left end of the rectangular space, wherein the upper-right end and the lower-left end are diagonal to each other.

As shown in FIG. 8, the opening 47 is formed at the upper-left portion of the side wall portion 44 and communicated to the air outlet opening 46E via the communication passage 48.

A partitioning member 50 is provided in the cell accommodating space 49, which extends from the side wall portion 43 to the side wall portion 44 in a horizontal direction. The partitioning member 50 is located above the air inlet opening 45E and has an L-shaped cross section. The partitioning member 50 prevents such a situation that the cooling air from the air inlet opening 45E does not pass through the battery cells 2 along the side surfaces 2c thereof and flows through an upper space above the battery cells 2. As shown in FIG. 8, upper-right corners of the respective battery cells 2 are in contact with the partitioning member 50, so that the battery cells 2 are firmly held in position.

As indicated by arrows in FIG. 6, the cooling air entering from the air inlet opening 45E into the cell accommodating space 49 flows toward the side wall portion 44 (opposite to the side wall portion 43), in the leftward direction in the drawing (in the layer direction of the battery cells 2). The cooling air further flows through gaps between the neighboring battery cells 2, which are layered in the direction from the side wall portion 43 to the side wall portion 44, in the downward direction in the drawing. The cooling air is collected at the opening 47 (at the upstream end of the communication passage 48) and flows through the communication passage in the downward direction. Then, the cooling air is finally discharged to the outside of the battery casing 4E from the air outlet opening 46E. As is also indicated by arrows in FIGS. 7 and 8, the cooling air flows from the lower-right end (the air inlet opening 45E) toward the upper-left end (the opening 47) of the cell accommodating space 49, that is, in a diagonal upward direction.

The above embodiment (FIGS. 6 to 8) may be modified in such a way that positions of the air inlet and outlet openings 45E and 46E are exchanged with each other. Namely, the air outlet opening 46E may be communicated with the lower portion of the cell accommodating space 49, while the air inlet opening 45E may be communicated to the upper portion of the cell accommodating space 49. Accordingly, one of the air inlet and outlet openings 45E and 46E may be communicated to the lower portion of the cell accommodating space 49, while the other inlet or outlet opening 45E or 46E may be communicated to the upper portion of the cell accommodating space 49 via the communication passage 48.

According to the above modification, the cooling air entering from the air inlet opening (which corresponds to the air outlet opening 46E in FIGS. 6 to 8) flows through the communication passage 48 in the upward direction and then flows into the cell accommodating space 49 via the opening 47. The cooling air further flows in the cell accommodating space 49 toward the side wall portion 43 (which is on the opposite side of the side wall portion 44), that is, in the right-hand direction in FIG. 6. The cooling air passes through the gaps between the respective battery cells 2, which are layered in the horizontal direction, in the upward direction in the drawing. The cooling air is collected at the lower portion of the cell accommodating space 49, that is, the area adjacent to the air outlet opening (which corresponds to the air inlet opening 45E in FIGS. 6 to 8), and finally discharged to the outside of the battery casing 4E. In the above air flow, the cooling air flows diagonally from the opening 47 to the air outlet opening (corresponding to the opening 45E), in a diagonal downward direction.

According to the present embodiment, the air flow is formed in the cell accommodating space 49 in the vertical direction from one of the air inlet and outlet openings 45E and 46E to the other opening. Therefore, when the battery cells 2 are cooled down by the forced convection of such air flow, the cooling air widely and totally flows in the cell accommodating space 49. As a result, the battery cells 2 can be equally and effectively cooled down.

In addition, when it is desired to keep the battery cells warm during a parking of the vehicle in the nighttime, the heated air is collected in the upper portion of the battery casing 4E. Since the forced convection of the air is not generated in such a situation, the heated air hardly flows out of the battery casing 4E through the air outlet opening 46E and/or the air inlet opening 45E due to the natural convection. As a result, the heat is not discharged to the outside of the battery casing 4E. Therefore, the power source device 1E has a temperature control function, that is, a function for cooling down the battery cells on one hand and another function for keeping the inside of the battery casing warm on the other hand.

The lower portion of the cell accommodating space 49, to which one of the air inlet and outlet openings 45E and 46E is communicated, and the upper portion of the cell accommodating space 49, to which the other opening 45E or 46E is communicated via the communication passage 48, are located diagonally in the cell accommodating space 48. When it is necessary to cool down the battery cells, the forced convection of the air is generated to form the air flow, so that the cooling diagonally flows in the cell accommodating space 49 from either the lower or upper portion thereof to the other upper or lower portion. Pressure loss in the air flow from the air inlet opening to the air outlet opening is uniformized so that the cooling air passes totally and equally through the battery cells. As a result, the cooling effect can be further increased.

What is claimed is:

1. An electric power source device comprising:
multiple battery cells, which are layered in a layer direction and electrically connected in series and/or in parallel;
a battery casing for accommodating the multiple battery cells, the battery casing being composed of a heat insulating structure at a portion surrounding the battery cells;
a heating unit provided between lower surfaces of the battery cells and a bottom plate of the battery casing for heating the battery cells; and
a heat storage layer provided between the heating unit and the bottom plate of the battery casing for storing heat generated at the heating unit.

2. The electric power source device according to the claim 1, wherein
the battery casing has an inlet opening through which temperature control fluid is taken into a cell accommodating space, which is an inside space of the battery casing,
the battery casing further has a discharge opening from which the temperature control fluid is discharged to an outside of the battery casing, and
each of the inlet opening and the discharge opening is provided at a lower portion of the battery casing.

3. The electric power source device according to the claim 2, wherein
one of the inlet opening and the discharge opening is communicated to a lower portion of the cell accommodating space, and
the other opening is communicated to an upper portion of the cell accommodating space through a communication passage, which vertically extends from the lower portion of the battery casing to the upper portion of the cell accommodating space.

4. The electric power source device according to the claim 3, wherein
the lower portion of the cell accommodating space, to which one of the inlet opening and the discharge opening is communicated, and the upper portion of the cell accommodating space, to which the other opening is communicated, are diagonally arranged in the cell accommodating space.

5. The electric power source device according to the claim 1, wherein
the battery casing has an inlet opening through which temperature control fluid is taken into a cell accommodating space, which is an inside space of the battery casing,
the battery casing further has a discharge opening from which the temperature control fluid is discharged to an outside of the battery casing, and
each of the inlet opening and the discharge opening is provided at a bottom plate of the battery casing.

6. The electric power source device according to the claim 1, wherein
the battery casing has an inlet opening through which temperature control fluid is taken into a cell accommodating space, which is an inside space of the battery casing,
the battery casing further has a discharge opening from which the temperature control fluid is discharged to an outside of the battery casing, and
each of the inlet opening and the discharge opening is provided at a respective side wall portion of the battery casing.

7. The electric power source device according to the claim 1, wherein
the battery casing has an inlet opening through which temperature control fluid is taken into a cell accommodating space, which is an inside space of the battery casing,
the battery casing further has a discharge opening from which the temperature control fluid is discharged to an outside of the battery casing, and
a door is provided at a portion adjacent to the inlet opening and/or the discharge opening for controlling flow of the temperature control fluid.

8. The electric power source device according to the claim 1, wherein
the heating unit is directly in contact with the lower surfaces of the battery cells or indirectly in contact with the lower surfaces via an electric insulating layer having heat conduction.

9. The electric power source device according to the claim 1, wherein
the heating unit is composed of a heat generating element which generates heat when electric current is supplied,
an outer packaging member of the battery cell is made of conducting material, and
an electric insulating layer having heat conduction is provided between the lower surface of the battery cell and the heat generating element.

10. The electric power source device according to the claim 1, further comprising;
another heating unit provided at side surfaces of the battery cells.

11. The electric power source device according to the claim 1, further comprising;
terminals provided at upper surfaces of the battery cells, the terminals being composed of positive electrodes and negative electrodes.

12. The electric power source device according to the claim 1, further comprising;
a fluid circuit having the heat storage layer and an electric component being used for a vehicle travel, for circulating heat storing fluid through the heat storage layer,
wherein the heat storing fluid cools down the electric component.
